(19) United States
(12) Patent Application Publication
(10) Pub. No.: US 2025/0160255 A1
(43) Pub. Date: May 22, 2025

(54) RETAINING GUARD FOR A COIL TINE OF AN AGRICULTURAL EQUIPMENT AND COIL TINE ASSEMBLY COMPRISING SAME

(71) Applicant: Groupe Anderson Inc., Chesterville (CA)

(72) Inventors: Pierre-Olivier Sarasin, Chesterville (CA); David Provencher, Chesterville (CA); Patrice Desrochers, Chesterville (CA); Raphaël-Soucy Gauthier, Chesterville (CA); Michaël Gagnon-Bouchard, Chesterville (CA)

(21) Appl. No.: 18/651,255

(22) Filed: Apr. 30, 2024

Related U.S. Application Data
(60) Provisional application No. 63/600,346, filed on Nov. 17, 2023.

(51) Int. Cl. A01D 80/02

(52) U.S. Cl. CPC A01D 80/02

(57) ABSTRACT

A retaining guard for a coil tine is provided. The retaining guard includes an elongated main portion having a securing channel adapted to receive an attachment member to mount the retaining guard to the rotating component of an agricultural equipment. The elongated main portion extends axially through the coil section along a first axis. The retaining guard also includes a retaining flap positioned at a first end of the elongated main portion adjacent to a prong of the coil tine and projecting towards the rotating component when the retaining guard is mounted thereon. The retaining flap is angled relative to the first axis and is sized and shaped to define a barrier preventing the coil section of the coil tine to move past the retaining flap along the first axis, in the occurrence of a break of a section of the coil tine.

### CROSS-REFERENCE TO RELATED APPLICATIONS

This application claims priority under 35 USC § 119(e) of US provisional patent application No. 63/600,346 filed on Nov. 17, 2023, the specification of which is hereby incorporated by reference.

### TECHNICAL FIELD

The present invention relates to the field of agricultural equipment and accessories thereof. More particularly it relates to parts of rotating components of agricultural equipment, and even more specifically to retaining guards for coil tines mounted to the rotating components of the agricultural equipment and to coil tine assemblies of such rotating components comprising the retaining guards.

### BACKGROUND

In the agricultural field, it is common for crops, once cut, to be raked and formed into windrows before being collected, using specialized machinery, or agricultural equipment, such as rotary rakes, mergers or the like. Such equipment is usually provided with rotating components having teeth, or tines, for raking the crops which are formed into windrows. Tines known in the art can include a coil section and a prong, such that forces applied to the prong of a tine are partially absorbed by the coil section, slowing the wear of the tine.

Usually, coil tines are mounted to the rotating component of the agricultural equipment with a main bolt. When a coil tine breaks off around the main bolt, pieces of the tine, including the coil section and the prong, may scatter and fall into the crops to be raked, or into the agricultural equipment. This can result in potential damaging of the agricultural equipment, potential health hazard for the livestock, and/or potential damaging of subsequent agricultural equipment if the pieces end up in the crops later processed by the subsequent agricultural equipment.

Therefore, there is a need for a retaining guard and/or a coil tine assembly comprising a retaining guard, which by virtue of its design and components, would be able to overcome or at least minimize some of the above-discussed concerns.

### SUMMARY

According to one aspect, there is provided a retaining guard for a coil tine having a coil section extending over a length, an attachment section positioned at a proximal end of the coil section and a prong positioned at a distal end of the coil section, the attachment section of the coil tine being sized and shaped to receive an attachment member for securing the coil tine to a rotating component of an agricultural equipment. The retaining guard comprises an elongated main portion having a securing channel adapted to receive the attachment member to mount the retaining guard to the rotating component of the agricultural equipment, the elongated main portion extending axially through the coil section along a first axis and having a length at least spanning the length of the coil section when the retaining guard is mounted to the rotating component of the agricultural equipment; and a retaining flap positioned at a first end of the elongated main portion adjacent to the prong of the coil tine and projecting towards the rotating component of the agricultural equipment when the retaining guard is mounted thereon, the retaining flap being angled relative to the first axis and being sized and shaped to define a barrier preventing the coil section of the coil tine to move past the retaining flap along the first axis, in the occurrence of a break of a section of the coil tine.

According to another aspect, there is provided a coil tine assembly. The coil time assembly comprises an attachment member for securing the coil tine assembly to a rotating component of an agricultural equipment; a coil tine having a coil section extending over a length, an attachment section positioned at a proximal end of the coil section and a prong positioned at a distal end of the coil section, the attachment section of the coil tine being sized and shaped to receive the attachment member for securing the coil tine to the rotating component of the agricultural equipment; and a retaining guard. The retaining guard comprises an elongated main portion having a securing channel adapted to receive the attachment member to mount the retaining guard to the rotating component of the agricultural equipment, the elongated main portion extending axially through the coil section along a first axis and having a length at least spanning the length of the coil section when the retaining guard is mounted to the rotating component of the agricultural equipment to secure the coil tine thereto; and a retaining flap positioned at a first end of the elongated main portion adjacent to the prong of the coil tine and projecting towards the rotating component of the agricultural equipment when the retaining guard is mounted thereon, the retaining flap being angled relative to the first axis and being sized and shaped to define a barrier preventing the coil section of the coil tine to move past the retaining flap along the first axis, in the occurrence of a break of a section of the coil tine.

### BRIEF DESCRIPTION OF THE DRAWINGS

Other objects, advantages and features will become more apparent upon reading the following non-restrictive description of embodiments thereof, given for the purpose of exemplification only, with reference to the accompanying drawings in which:

FIG. 1 is a perspective view of a rotating component of an agricultural equipment, according to an embodiment including coil tines mounted on a peripheral wall of a tubular body, according to an embodiment where the coil tines include two prongs.

FIG. 2 is a front elevation view of the rotating component of FIG. 1.

FIG. 3 is an enlarged view of a section of the rotating component of FIG. 2 showing coil tines assemblies mounted on the peripheral wall of a tubular body.

FIG. 4 is an enlarged view of one of the tine assemblies shown in FIG. 3, including a retaining guard.

FIG. 5 is a front elevation view of the coil tine assembly of FIG. 4, including the retaining guard shown without the rotating component.

FIG. 6 is a cross-section view of the coil tine assembly of FIG. 5.

FIG. 7 is an exploded view of the retaining guard of FIGS. 5 and 6 shown along with an attachment member.

FIG. 8 is a perspective view of the coil tine assembly of FIG. 5.

FIG. 9 is a front elevation view of a coil tine assembly including a retaining guard, according to an embodiment where the coil tine includes a single prong.

FIG. 10 is a side elevation view of the coil tine assembly of FIG. 9.

### DETAILED DESCRIPTION

In the following description, the same numerical references refer to similar elements. Furthermore, for the sake of simplicity and clarity, namely, so as to not unduly burden the figures with several reference numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures or described in the present disclosure are embodiments only, given solely for exemplification purposes.

Moreover, although the embodiments of the retaining guard, the coil tine assembly, and corresponding parts thereof consist of certain geometrical configurations as explained and illustrated herein, not all of these components and geometries are needed and thus should not be taken in their restrictive sense. It is to be understood, as also apparent to a person skilled in the art, that other suitable components and cooperation thereinbetween, as well as other suitable geometrical configurations, may be used for the retaining guard and/or for the coil tine assembly, as will be briefly explained herein and as can be easily inferred herefrom by a person skilled in the art. Moreover, it will be appreciated that positional descriptions such as “above”, “below”, “left”, “right” and the like should, unless otherwise indicated, be taken in the context of the figures and should not be considered limiting.

To provide a more concise description, some of the quantitative and qualitative expressions given herein may be qualified with the terms “about” and “substantially”. It is understood that whether the terms “about” and “substantially” are used explicitly or not, every quantity or qualification given herein is meant to refer to an actual given value or qualification, and it is also meant to refer to the approximation to such given value or qualification that would reasonably be inferred based on the ordinary skill in the art, including approximations due to the experimental and/or measurement conditions for such given value.

The terms “a”, “an” and “one” are defined herein to mean “at least one”, that is, these terms do not exclude a plural number of items, unless stated otherwise.

Unless stated otherwise, the terms “connected” and “coupled”, and derivatives and variants thereof, refer herein to any structural or functional connection or coupling, either direct or indirect, between two or more elements. For example, the connection or coupling between the elements can be acoustical, mechanical, optical, electrical, thermal, logical, or any combinations thereof.

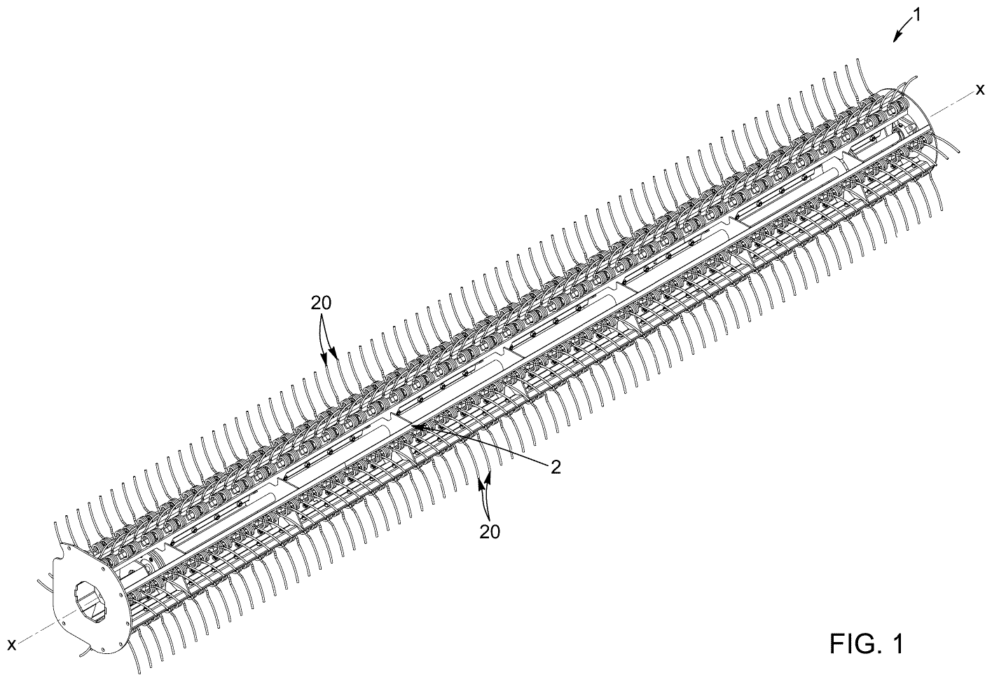

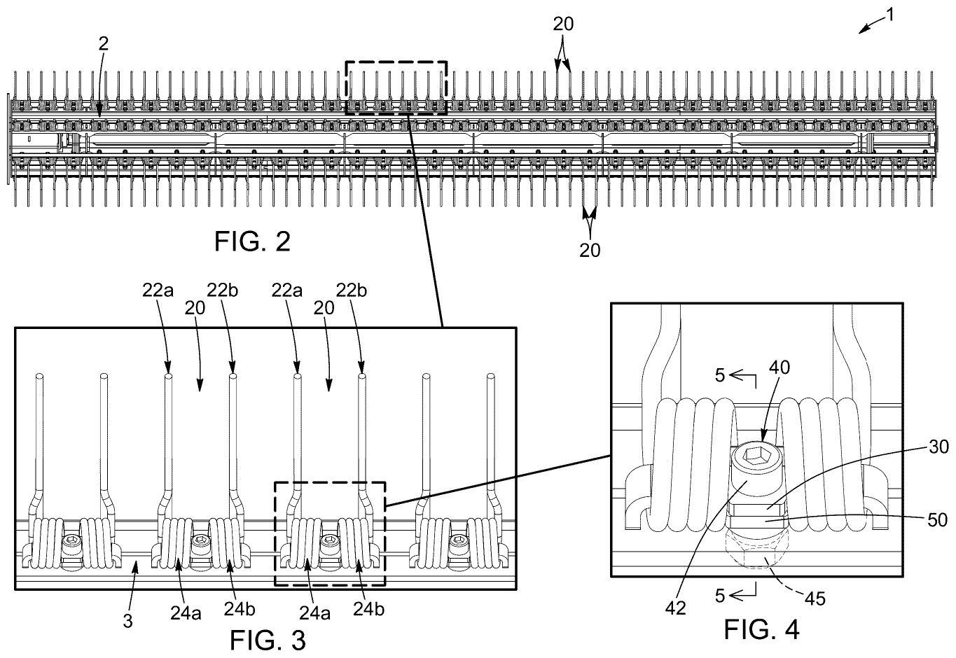

Referring now to the drawings and more particularly to FIGS. 1 and 2, there is shown a rotating component 1 of an agricultural equipment, such as, for example and without being limitative, a hay rake, a hay merger, a hay baler or the like, in accordance with an embodiment. In some embodiment, the rotating component 1 can be installed on an agricultural harvesting machine and can be rotatable around a rotation axis x. In the embodiment shown, the rotating component 1 comprises a substantially tubular body 2 having a peripheral wall 3 extending along the rotation axis x and a plurality of coil tines 20 mounted on the peripheral wall 3 of the tubular body 2. The plurality of coil tines 20 can extend substantially perpendicularly and outwardly from the peripheral wall 3 of the tubular body 2, the plurality of coil tines 20 being spread over a perimeter of the tubular body 2 and over a length of the tubular body 2.

In the illustrated embodiment, and as best shown in FIGS. 3 and 4, each coil tine 20 further comprises two coil sections 24a-24b and two prongs 22a-22b. Each coil tine 20 can further be secured to the peripheral wall 3 of the tubular body 2 using an attachment member 40, thereby forming a coil tine assembly 10.

Referring more particularly to FIGS. 3 to 8, in an embodiment the coil tine assembly 10 includes a retaining guard 30 adapted to be mounted, or secured, together with a coil tine 20 onto the peripheral wall 3 of the tubular body 2 of the rotating component 2 of the agricultural equipment. In an embodiment, the retaining guard 30 is securely connected to the peripheral wall 3 of the tubular body 2 by the attachment member 40, as will be further detailed below. The retaining guard 30 is advantageously configured to be mounted relative to the coil tine 20 such that, in the occurrence of a portion of the coil tine 20 breaking off around the attachment member 40 securing the coil tine 20 and the retaining guard 30 to the peripheral wall 3 of the tubular body 2 of the rotating component 1 of the agricultural equipment, the broken portions of the coil tine 20 are retained onto the rotating component 1, thereby preventing the scattering of the pieces. The retaining guard 30 proposed herein thereby alleviates drawbacks of conventional coil tines assembly, by maintaining the potential scattered pieces of broken coil tines and preventing them from moving into the crops to be raked, or into undesired portions of the agricultural equipment. The retaining guard 30 therefore prevents potential damages of the agricultural equipment, potential health hazard for the livestock, and/or potential damages of additional agricultural equipments which could subsequently process crops including the broken coil tines portions.

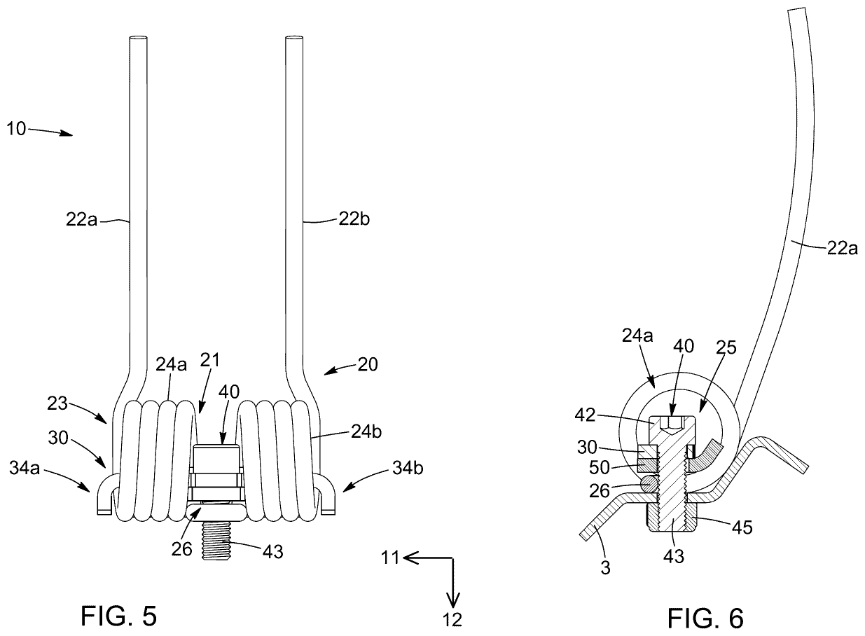

Turning to FIG. 5, in the embodiment shown the coil tine 20 includes two coil sections 24a-24b oppositely extending along a first axis 11 and extending substantially parallel to the rotation axis x of the tubular body 2. That is, both coil sections 24a-24b extend over a length in generally opposite directions along the first axis 11. In a preferred embodiment, the length of the first coil section 24a is substantially equal to the length of the second coil section 24b. Each coil section 24a, 24b includes a proximal end 21 and a distal end 23. The coil tine 20 further includes two prongs 22a-22b each positioned at a respective distal end 23 of the corresponding one of the two coil sections 24a-24b. The prongs 22a-22b, or teeth, are adapted to come in contact with the soil or the crops when the coil tines 20 are mounted to the peripheral wall 3 of the tubular body 2 of the rotating component 1 of an operating agricultural equipment. The coil tine 20 further includes an attachment section 26 positioned between the coil sections 24a-24b and linked to each proximal end 21 of the coil section 24a-24b, thereby linking the first coil section 24a with the second coil section 24b.

In some embodiment, the coil tine 20 can be made of a single metal wire including the first prong 22a, a rolled section forming the first coil section 24a, a folded section forming the attachment section 26, another rolled section forming the second coil section 24b, and the second prong 22b. One skilled in the art will readily understand that in other variants one or more of the segments of the coil tine 20 may be a separate component connected to one another using any connecting mean.

The coil tine 20 is adapted to be mounted to the peripheral wall 3 of the tubular body 2 of the rotating component 1 of the agricultural equipment using an attachment member 40. The attachment section 26 is therefore sized and shaped to receive the attachment member 40, allowing mounting, attaching, or securing of the coil tine 20 to the peripheral wall 3 of the tubular body 2 of the rotating component 1 of the agricultural equipment. In an embodiment, the attachment section 26 is substantially hook-shaped, with each of the two coil sections 24a-24b being linked at their proximal end 21 to a respective end of the attachment section 26. In alternate embodiments, the attachment section 26 can be loop-shaped, or any other shape suitable for receiving the attachment member 40.

In an embodiment, the attachment member 40 can be removably mounted to the peripheral wall 3 of the tubular body 2 of the rotating component 1 of the agricultural equipment, to secure the coil tine 20 to the rotating component of the agricultural equipment. For example, and without being limitative, in one embodiment, the attachment member 40 is a bolt 41 securable to the peripheral wall 3 of the tubular body 2 of the rotating component 1 of the agricultural equipment, as will be further detailed below. In other embodiments, the attachment member 40 can comprise a plurality of bolts or screws securable to the agricultural equipment, for example.

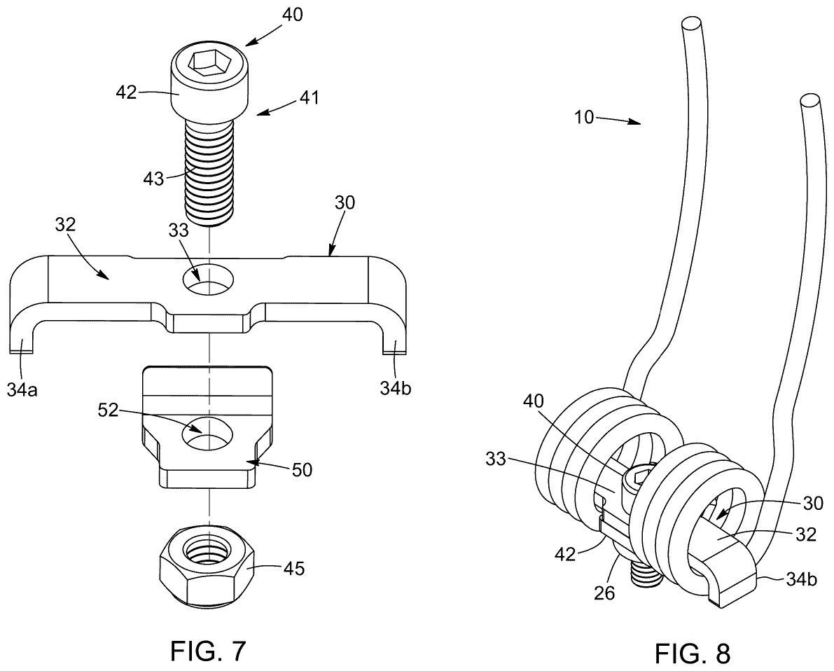

Furthermore, in some embodiments, as shown in FIG. 7, the attachment member 40 is part of an attachment assembly and further includes a securing plate 50 having a securing channel 52 and configured to receive the attachment member 40 therethrough. In some embodiment, the securing plate 50 is substantially extending horizontally along the first axis 11, and lateral sides of the securing plate 50 can be slightly indented to complementary receive internal side of the first and second coil sections 24a, 24b. When the retaining guard 30 is secured to the peripheral wall, the securing plate 50 is sandwiched between the retaining guard 30 and the peripheral wall 3 of the tubular body 2 of the rotating component 1.

Referring to FIG. 7, the retaining guard 30 adapted to be mounted to the peripheral wall 3 of the tubular body 2 of the rotating component 1 of the agricultural equipment, includes an elongated main portion 32 having a securing channel 33 adapted to receive the attachment member 40. That is, the retaining guard 30 is adapted to be removably secured together with the coil tine 20 to be mounted onto the peripheral wall 3 of the tubular body 2 of the rotating component 1 of the agricultural equipment using the attachment member 40. The elongated main portion 32 extends generally axially, along the first axis 11, through the first and second coil sections 24a-24b when the retaining guard 30 is mounted to the peripheral wall 3 of the tubular body 2 of the rotating component 1 of the agricultural equipment to secure the coil tine 20 thereon. The main portion 32 of the retaining guard 30 has a length at least spanning the length of both coil sections 24a-24b such that the elongated main portion 32 extends at least from the distal end of the first coil section 24a to the distal end of the second coil section 24b. In some embodiment, the elongated main portion 32 of the retaining guard 30 can also being slightly indented around the securing channel 33, such that the indentation of the elongated main portion 32 of the retaining guard 30 is substantially aligned with the indentation of the securing plate 50 once secured together.

In the illustrated embodiment of FIGS. 6 and 7, the attachment member 40 comprises a bolt 41 with a head 42 and a rod 43, the rod 43 being threaded to receive a nut 45, the threaded rod 43 being inserted through the securing channel 33 of the retaining guard 30, through the securing channel 52 of the securing plate 50, through the attachment section 26 of the coil tine 20 and through a hole in the peripheral wall 3 of the tubular body 2 of the rotating component. The coil tine assembly 10 is therefore attached and secured using a nut 45 positioned in an inner face of the peripheral wall, with the nut 45, the nut 45 being tightened until the nut presses against the inner surface of the peripheral wall 3 of the tubular body 2 of the rotating component 1. One skilled in the art will understand that, in alternative embodiments, the threaded rod 43 section of the nut 45 could rather be directly screwed into corresponding threads defined in the tubular body 2, therefore avoiding the use of nuts 45.

The retaining guard 30 also includes retaining flaps 34a-34b each positioned at respective ends of the elongated main portion 32. As best seen in FIG. 5, a first retaining flap 34a is positioned at a first end of the elongated main portion 32, adjacent to the first prong 22a, and a second retaining flap 34b is positioned at a second end of the elongated main portion 32, adjacent to the second prong 22b. Both retaining flaps 34a-34b generally project towards the peripheral wall 3 of the tubular body 2 of the rotating component 1 of the agricultural equipment and along a second axis 12 when the retaining guard 30 is mounted to the agricultural equipment. The retaining flaps 34a-34b therefore define an angle relative to the elongated main portion 32. The shape, length and angle defined by each retaining flap 34a-34b defines a barrier for each of the coil sections 24a-b along the first axis 11. In the occurrence of the first coil section 24a breaking off, the retaining flap 34a is adapted to prevent a broken-off portion of the first coil section 24a from moving past the retaining flap 34a along the first axis 11. Likewise, in the occurrence of the second coil section 24b breaking off, the retaining flap 34b is adapted to prevent a broken-off portion the second coil section 24b from moving past the retaining flap 34b along the first axis 11.

In a preferred embodiment shown in FIGS. 5, 7 and 8, the retaining flaps 34a-34b are angled substantially perpendicular relative to the elongated main portion 32. However, it should be understood that other configurations of the retaining flaps 34a-34b may be contemplated without departing from the present disclosure. Indeed, the relative angle between the retaining flaps 34a-34b and the elongated main portion 32 may vary, as long as the coil sections 24a-24b are retained and prevented from moving past the retaining flaps 34a-34b along the first axis 11. One skilled in the art will understand that in alternative embodiments, the angle of each one of the retaining flaps 34a-34b relative to the main portion 32 may be different from one another.

Further, in the embodiment of FIGS. 5 to 8, the elongated main portion 32 and the retaining flaps 34a-34b are each generally rectangular and are preferably formed in a single piece. For example, the retaining flaps 34a-34b may be formed by bending the ends of a single metallic piece. However, other shapes and configurations can be contemplated without departing from the present disclosure. For example, the retaining flaps 34a-34b can be separate pieces joined to the elongated main portion 32 by welding, soldering, riveting, bolting or the like.

Turning to FIG. 6, the retaining guard 30 is generally sized, shaped and positioned such as to be spaced apart from the coil sections 24a-24b within a channel 25 formed by the coil sections 24a-24b. The elongated main portion 32 of the retaining guard 30 therefore extends substantially axially in the channel 25 formed by the coil sections 24a-24b without connecting with the coil sections 24a-24b (i.e. without pressing the coil sections 24a-24b against the peripheral wall 3 of the tubular body 2 of the rotating component 1 of the agricultural equipment).

Further in an embodiment, the retaining flaps 32a-32b are spaced part from the coil sections 24a-b and the prongs 22a-b. This configuration advantageously prevents the retaining guard 30 from impeding on the movement of the coil tine 20.

Furthermore in an embodiment, the retaining flaps 34a-34b are spaced apart from the peripheral wall 3 of the tubular body 2 of the rotating component 1 of the agricultural equipment, when the retaining guard 30 is mounted to the rotating component of the agricultural equipment, via the attachment member 40, to secure the coil tine 20 to the rotating component of the agricultural equipment, thereby creating a space between a tip of each retaining flap 34a, 34b and the surface of the rotating component of the agricultural equipment. This advantageously prevents the retaining guard 30, and more specifically the retaining flaps 34a-34b, from impeding on a proper securing of the attachment member 40 to the agricultural equipment, thereby ensuring a secure fastening of the coil tine 20 and the retaining guard 30 to the peripheral wall 3 of the tubular body 2 of the rotating component 1 of the agricultural equipment. However, the space formed between the peripheral wall 3 of the tubular body 2 of the rotating component 1 of the agricultural equipment and the retaining flaps 34a-34b is smaller than a thickness, or diameter, of a rod, or piece, forming the coil section, such that the barrier formed by each retaining flap 34a-34b still prevents broken-off pieces from moving past the retaining flaps 34a-34b along the first axis 11. In other embodiments, the retaining flaps 34a-34b can connect with the peripheral wall 3 of the tubular body 2 of the rotating component 1 when the retaining guard 30 is mounted to the rotating component of the agricultural equipment.

While the embodiment of FIGS. 1 to 8 is particularly adapted for mounting with a coil tine 20 having two coil sections 24a-24b and two prongs 22a-22b, other embodiments of the retaining guard 30 are adapted for mounting with coil tines having different configurations.

Referring to 9 and 10, there is shown an alternative embodiment of the coil tine assembly 10 wherein the features are numbered with reference numerals in the 100 series which correspond to the reference numerals of the previous embodiment.

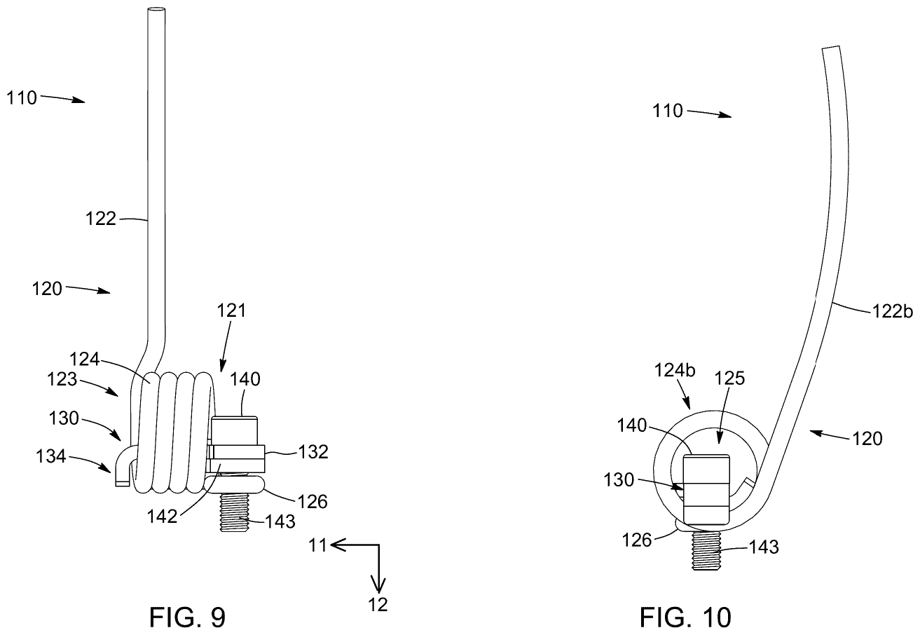

In the embodiment shown in FIG. 9, the retaining guard 130 provided is adapted to be mounted together with a coil tine 120 onto a peripheral wall of a tubular body of a rotating component of an agricultural equipment (not shown). In FIG. 9, the coil tine assembly 110, including both the coil tine 120 and the retaining guard 130, is shown. The coil tine 120 includes a single coil section 124 and a single prong 122 positioned at a distal end 123 of the coil section 124. The coil tine 120 also includes an attachment section 126 positioned at a proximal end 121 of the coil section 124. The attachment section 126 is once again sized and shaped so as to receive the attachment member 140, for securely fastening the coil tine 120 to the peripheral wall of the tubular body of the rotating component of the agricultural equipment. The retaining guard 130 includes an elongated main portion 132 extending through the coil section 124 and having a length spanning at least the length of the coil section 124 when the retaining guard 130 is mounted to the peripheral wall of the tubular body of the rotating component of the agricultural equipment to secure the coil tine 120 thereto. The elongated main portion 132 also includes a channel at one end adapted to receive the attachment member 140 therein. The retaining guard 130 includes one retaining flap 134 positioned adjacent to the prong 122 and projecting towards the rotating component of the agricultural equipment when the retaining guard 130 is mounted thereon. As in the exemplary embodiment described hereinabove with reference to FIGS. 1 to 8, the retaining flap 134 is positioned, sized and shaped so as to define a barrier to prevent the coil section 124 from moving past the retaining flap 134 along the first axis 11, in the occurrence of a section of the coil tine 120 breaking off.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention could be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind.

The scope of the invention is therefore intended to be limited solely by the scope of the appended claims.

Embodiments of the present invention as described herein include the following aspects:

1. A retaining guard for a coil tine having a coil section extending over a length, an attachment section positioned at a proximal end of the coil section and a prong positioned at a distal end of the coil section, the attachment section of the coil tine being sized and shaped to receive an attachment member for securing the coil tine to a rotating component of an agricultural equipment, the retaining guard comprising:
an elongated main portion having a securing channel adapted to receive the attachment member to mount the retaining guard to the rotating component of the agricultural equipment, the elongated main portion extending axially through the coil section along a first axis and having a length at least spanning the length of the coil section when the retaining guard is mounted to the rotating component of the agricultural equipment; and
a retaining flap positioned at a first end of the elongated main portion adjacent to the prong of the coil tine and projecting towards the rotating component of the agricultural equipment when the retaining guard is mounted thereon, the retaining flap being angled relative to the first axis and being sized and shaped to define a barrier preventing the coil section of the coil tine to move past the retaining flap along the first axis, in an occurrence of a break of a section of the coil tine.

2. The retaining guard of aspect 1, wherein the retaining guard is sized and shaped for the elongated main portion and the retaining flap to be spaced apart from the coil section and the prong of the coil tine to prevent impeding a movement thereof when the retaining guard is mounted to the rotating component of the agricultural equipment to secure the coil tine thereto.

3. The retaining guard of aspect 1 or 2, wherein the retaining guard is sized and shaped for a tip of the retaining flap of the retaining guard to be spaced apart from a surface of the rotating component of the agricultural equipment, when the retaining guard is mounted to the rotating component of the agricultural equipment to ensure a secure fastening of the coil tine to the agricultural equipment.

4. The retaining guard of aspect 3, wherein the coil tine is formed using a rod having a thickness and a spacing width between the tip of the retaining flap and the surface of the rotating component of the agricultural equipment is smaller than the thickness of the rod forming the coil tine to prevent the coil section of the coil tine to move past the retaining flap along the first axis, in the occurrence of a break of a section of the coil tine.

5. The retaining guard of any one of aspects 1 to 4, wherein the retaining flap extends substantially perpendicular to the elongated main portion.

6. The retaining guard of any one of aspects 1 to 5, wherein the retaining flap is of a substantially rectangular shape.

7. The retaining guard of any one of aspects 1 to 6, wherein the elongated main portion and the retaining flap are formed in a single piece.

8. The retaining guard of any one of aspects 1 to 7, wherein the coil tine includes a first coil section with a first prong positioned at a distal end thereof and a second coil section with a second prong positioned at a distal end thereof, the attachment section linking the first coil section and the second coil section and being positioned therebetween, and wherein:
the elongated main portion of the retaining guard extends axially through the first coil section and the second coil section along the first axis and has a length at least spanning the length of the first coil section and the second coil section when the retaining guard is mounted to the rotating component of the agricultural equipment; and
a first retaining flap positioned at the first end of the elongated main portion adjacent to the first prong of the first coil section and a second retaining flap positioned at a second end of the elongated main portion adjacent to the second prong of the second coil section, with the first retaining flap and second retaining flap projecting towards the rotating component of the agricultural equipment when the retaining guard is mounted thereon, the first retaining flap and the second retaining flap being angled relative to the first axis and being sized and shaped to define a barrier preventing respectively the first coil section and the second coil section of the coil tine to move past the corresponding one of the first retaining flap and second retaining flap along the first axis, in the occurrence of a break of a section of the coil tine.

9. The retaining guard of any one of aspects 1 to 8, wherein the retaining guard is adapted for the attachment member to comprise a bolt inserted through the securing channel of the retaining guard and through a hole in the rotating component of the agricultural equipment.

10. A coil tine assembly comprising:
an attachment member for securing the coil tine assembly to a rotating component of an agricultural equipment;
a coil tine having a coil section extending over a length, an attachment section positioned at a proximal end of the coil section and a prong positioned at a distal end of the coil section, the attachment section of the coil tine being sized and shaped to receive the attachment member for securing the coil tine to the rotating component of the agricultural equipment; and
a retaining guard comprising:
   an elongated main portion having a securing channel adapted to receive the attachment member to mount the retaining guard to the rotating component of the agricultural equipment, the elongated main portion extending axially through the coil section along a first axis and having a length at least spanning the length of the coil section when the retaining guard is mounted to the rotating component of the agricultural equipment to secure the coil tine thereto; and
   a retaining flap positioned at a first end of the elongated main portion adjacent to the prong of the coil tine and projecting towards the rotating component of the agricultural equipment when the retaining guard is mounted thereon, the retaining flap being angled relative to the first axis and being sized and shaped to define a barrier preventing the coil section of the coil tine to move past the retaining flap along the first axis, in the occurrence of a break of a section of the coil tine.

11. The coil tine assembly of aspect 10, wherein the elongated main portion and the retaining flap are spaced apart from the coil section and the prong of the coil tine to prevent impeding the movement thereof when the retaining guard is mounted to the rotating component of the agricultural equipment to secure the coil tine thereto.

12. The coil tine assembly of aspect 11, further comprising a securing plate nested between the retaining guard and the rotating component of the agricultural equipment when the retaining guard is mounted to the rotating component of the agricultural equipment allow, to maintain the elongated main portion and the retaining flap spaced apart from the coil section and the prong of the coil tine.

13. The coil tine assembly of any one of aspects 10 to 12, wherein a tip of the retaining flap of the retaining guard is spaced apart from a surface of the rotating component of the agricultural equipment, when the retaining guard is mounted to the rotating component of the agricultural equipment to ensure a secure fastening of the coil tine to the agricultural equipment.

14. The coil tine assembly of aspect 13, wherein the coil tine is formed using a rod having a thickness and a spacing width between the tip of the retaining flap and the surface of the rotating component of the agricultural equipment is smaller than the thickness of the rod forming the coil tine to prevent the coil section of the coil tine to move past the retaining flap along the first axis, in the occurrence of a break of a section of the coil tine.

15. The coil tine assembly of any one of aspects 10 to 14, wherein the retaining flap of the retaining guard extends substantially perpendicular to the elongated main portion.

16. The coil tine assembly of any one of aspects 10 to 15, wherein the retaining flap of the retaining guard is of a substantially rectangular shape.

17. The coil tine assembly of any one of aspects 10 to 16, wherein the retaining guard is a single piece component.

18. The coil tine assembly of any one of aspects 10 to 17, wherein the coil section, the attachment section and the prong are formed in a single piece.

19. The coil tine assembly of any one of aspects 10 to 18, wherein the coil tine includes a first coil section with a first prong positioned at a distal end thereof and a second coil section with a second prong positioned at a distal end thereof, the attachment section linking the first coil section and the second coil section and being positioned therebetween, and wherein:
the elongated main portion of the retaining guard extends axially through the first coil section and the second coil section along the first axis and has a length at least spanning the length of the first coil section and the second coil section when the retaining guard is mounted to the rotating component of the agricultural equipment; and
a first retaining flap positioned at the first end of the elongated main portion adjacent to the first prong of the first coil section and a second retaining flap positioned at a second end of the elongated main portion adjacent to the second prong of the second coil section, with the first retaining flap and second retaining flap projecting towards the rotating component of the agricultural equipment when the retaining guard is mounted thereon, the first retaining flap and second retaining flap being angled relative to the first axis and being sized and shaped to define a barrier preventing respectively the first coil section and the second coil section of the coil tine to move past the corresponding one of the first retaining flap and second retaining flap along the first axis, in the occurrence of a break of a section of the coil tine.

20. The coil tine assembly of any one of aspects 10 to 19, wherein the attachment member further comprises a bolt inserted through the securing channel of the retaining guard and through a hole in the rotating component of an agricultural equipment.

1. A retaining guard for a coil tine having a coil section extending over a length, an attachment section positioned at a proximal end of the coil section and a prong positioned at a distal end of the coil section, the attachment section of the coil tine being sized and shaped to receive an attachment member for securing the coil tine to a rotating component of an agricultural equipment, the retaining guard comprising:
an elongated main portion having a securing channel adapted to receive the attachment member to mount the retaining guard to the rotating component of the agricultural equipment, the elongated main portion extending axially through the coil section along a first axis and having a length at least spanning the length of the coil section when the retaining guard is mounted to the rotating component of the agricultural equipment; and
a retaining flap positioned at a first end of the elongated main portion adjacent to the prong of the coil tine and projecting towards the rotating component of the agricultural equipment when the retaining guard is mounted thereon, the retaining flap being angled relative to the first axis and being sized and shaped to define a barrier preventing the coil section of the coil tine to move past the retaining flap along the first axis, in an occurrence of a break of a section of the coil tine.

2. The retaining guard of claim 1, wherein the retaining guard is sized and shaped for the elongated main portion and the retaining flap to be spaced apart from the coil section and the prong of the coil tine to prevent impeding a movement thereof when the retaining guard is mounted to the rotating component of the agricultural equipment to secure the coil tine thereto.

3. The retaining guard of claim 1, wherein the retaining guard is sized and shaped for a tip of the retaining flap of the retaining guard to be spaced apart from a surface of the rotating component of the agricultural equipment, when the retaining guard is mounted to the rotating component of the agricultural equipment to ensure a secure fastening of the coil tine to the agricultural equipment.

4. The retaining guard of claim 3, wherein the coil tine is formed using a rod having a thickness and a spacing width between the tip of the retaining flap and the surface of the rotating component of the agricultural equipment is smaller than the thickness of the rod forming the coil tine to prevent the coil section of the coil tine to move past the retaining flap along the first axis, in the occurrence of a break of a section of the coil tine.

5. The retaining guard of claim 1, wherein the retaining flap extends substantially perpendicular to the elongated main portion.

6. The retaining guard of claim 1, wherein the retaining flap is of a substantially rectangular shape.

7. The retaining guard of claim 1, wherein the elongated main portion and the retaining flap are formed in a single piece.

8. The retaining guard of claim 1, wherein the coil tine includes a first coil section with a first prong positioned at a distal end thereof and a second coil section with a second prong positioned at a distal end thereof, the attachment section linking the first coil section and the second coil section and being positioned therebetween, and wherein:
the elongated main portion of the retaining guard extends axially through the first coil section and the second coil section along the first axis and has a length at least spanning the length of the first coil section and the second coil section when the retaining guard is mounted to the rotating component of the agricultural equipment; and
a first retaining flap positioned at the first end of the elongated main portion adjacent to the first prong of the first coil section and a second retaining flap positioned at a second end of the elongated main portion adjacent to the second prong of the second coil section, with the first retaining flap and second retaining flap projecting towards the rotating component of the agricultural equipment when the retaining guard is mounted thereon, the first retaining flap and the second retaining flap being angled relative to the first axis and being sized and shaped to define a barrier preventing respectively the first coil section and the second coil section of the coil tine to move past the corresponding one of the first retaining flap and second retaining flap along the first axis, in the occurrence of a break of a section of the coil tine.

9. The retaining guard of claim 1, wherein the retaining guard is adapted for the attachment member to comprise a bolt inserted through the securing channel of the retaining guard and through a hole in the rotating component of the agricultural equipment.

10. A coil tine assembly comprising:
an attachment member for securing the coil tine assembly to a rotating component of an agricultural equipment;
a coil tine having a coil section extending over a length, an attachment section positioned at a proximal end of the coil section and a prong positioned at a distal end of the coil section, the attachment section of the coil tine being sized and shaped to receive the attachment member for securing the coil tine to the rotating component of the agricultural equipment; and
a retaining guard comprising:
an elongated main portion having a securing channel adapted to receive the attachment member to mount the retaining guard to the rotating component of the agricultural equipment, the elongated main portion extending axially through the coil section along a first axis and having a length at least spanning the length of the coil section when the retaining guard is mounted to the rotating component of the agricultural equipment to secure the coil tine thereto; and
a retaining flap positioned at a first end of the elongated main portion adjacent to the prong of the coil tine and projecting towards the rotating component of the agricultural equipment when the retaining guard is mounted thereon, the retaining flap being angled relative to the first axis and being sized and shaped to define a barrier preventing the coil section of the coil tine to move past the retaining flap along the first axis, in the occurrence of a break of a section of the coil tine.

11. The coil tine assembly of claim 10, wherein the elongated main portion and the retaining flap are spaced apart from the coil section and the prong of the coil tine to prevent impeding the movement thereof when the retaining guard is mounted to the rotating component of the agricultural equipment to secure the coil tine thereto.

12. The coil tine assembly of claim 11, further comprising a securing plate nested between the retaining guard and the rotating component of the agricultural equipment when the retaining guard is mounted to the rotating component of the agricultural equipment allow, to maintain the elongated main portion and the retaining flap spaced apart from the coil section and the prong of the coil tine.

13. The coil tine assembly of claim 10, wherein a tip of the retaining flap of the retaining guard is spaced apart from a surface of the rotating component of the agricultural equipment, when the retaining guard is mounted to the rotating component of the agricultural equipment to ensure a secure fastening of the coil tine to the agricultural equipment.

14. The coil tine assembly of claim 13, wherein the coil tine is formed using a rod having a thickness and a spacing width between the tip of the retaining flap and the surface of the rotating component of the agricultural equipment is smaller than the thickness of the rod forming the coil tine to prevent the coil section of the coil tine to move past the retaining flap along the first axis, in the occurrence of a break of a section of the coil tine.

15. The coil tine assembly of claim 10, wherein the retaining flap of the retaining guard extends substantially perpendicular to the elongated main portion.

16. The coil tine assembly of claim 10, wherein the retaining flap of the retaining guard is of a substantially rectangular shape.

17. The coil tine assembly of claim 10, wherein the retaining guard is a single piece component.

18. The coil tine assembly of claim 10, wherein the coil section, the attachment section and the prong are formed in a single piece.

19. The coil tine assembly of claim 10, wherein the coil tine includes a first coil section with a first prong positioned at a distal end thereof and a second coil section with a second prong positioned at a distal end thereof, the attachment section linking the first coil section and the second coil section and being positioned therebetween, and wherein:
the elongated main portion of the retaining guard extends axially through the first coil section and the second coil section along the first axis and has a length at least spanning the length of the first coil section and the second coil section when the retaining guard is mounted to the rotating component of the agricultural equipment; and
a first retaining flap positioned at the first end of the elongated main portion adjacent to the first prong of the first coil section and a second retaining flap positioned at a second end of the elongated main portion adjacent to the second prong of the second coil section, with the first retaining flap and second retaining flap projecting towards the rotating component of the agricultural equipment when the retaining guard is mounted thereon, the first retaining flap and second retaining flap being angled relative to the first axis and being sized and shaped to define a barrier preventing respectively the first coil section and the second coil section of the coil tine to move past the corresponding one of the first retaining flap and second retaining flap along the first axis, in the occurrence of a break of a section of the coil tine.

20. The coil tine assembly of claim 10, wherein the attachment member further comprises a bolt inserted through the securing channel of the retaining guard and through a hole in the rotating component of an agricultural equipment.
